(19) United States
(12) Patent Application Publication
(10) Pub. No.: US 2006/0237975 A1
(43) Pub. Date: Oct. 26, 2006

(54) LOCK MOUNTING PLATE HAVING ANTI-LOOSENING STRUCTURE FOR CONNECTING WITH A FIXING MEMBER

(75) Inventor: Chiang-Lin Hsueh, Yung An Hsiang (TW)

Correspondence Address: NIKOLAI & MERSEREAU, P.A., 900 SECOND AVENUE SOUTH, SUITE 820, MINNEAPOLIS, MN, 55402, US

(73) Assignee: TAIWAN FU HSING INDUSTRIAL CO., LTD., Kang-Shan Chen (TW)

(21) Appl. No.: 10/908,049

(22) Filed: Apr. 26, 2005

(51) Int. Cl. E05B 3/00

(52) U.S. Cl. 292/358

(57) ABSTRACT

An anti-loosening structure is applied to a lock mounting plate of a door lock mechanism and a fixing member. The lock mounting plate includes an axial hole and at least one assembling hole having a fastener portion on a periphery thereof. Correspondingly, the fixing member includes a head portion, a shank portion and a detent portion formed on the head portion proximate to the shank portion. The fastener portion of the lock mounting plate is connected with the detent portion of the fixing member such that the engagement of the fixing member with the lock mounting plate is insured when the fixing member mounts the lock mounting plate to a door plank.

### BACKGROUND OF THE INVENTION

1. Field of the Invention

The present invention relates to a lock mounting plate having an anti-loosening structure for connecting with a fixing member. Particularly, the present invention relates to the lock mounting plate provided with a fastener portion and the fixing member provided with a detent portion. More particularly, the present invention relates to the lock mounting plate having the fastener portion for connecting with the detent portion of the fixing member.

2. Description of the Related Art

In general, a conventional door lock structure, as shown in FIG. 1, includes a lock mounting plate 1, a doorknob 2 and a returning spring 3. A plurality of fasteners 4 such as screw members or other equivalent attachment structures is normally applied to the lock mounting plate 1. The lock mounting plate 1 may have any shape or contour desired, but it must have an axial hole 11 and a plurality of assembling holes 12. In installation, secured to either side of the axial hole 11 of the lock mounting plate 1 in an intended manner are the doorknob 2 and the returning spring 3. Typically, the fasteners 4 securely mount the lock mounting plate 1 and a lock set (not shown) to a drilled hole of an object (not shown) such as a door plank once tightened.

In use, the doorknob 2 is repeatedly turned a predetermined angular movement by hand, and automatically returned to an original position by a returning force exerted by the returning spring 3. When this occurs, the returning doorknob 2 and the returning spring 3 may result in vibration on the lock mounting plate 1. Such vibration may, however, cause the fastener 4 gone into a slide on the assembling hole 12 of the lock mounting plate 1 since no skidproof structure is formed between flat surfaces of the assembling hole 12 and the fastener 4. After long-term use, this may cause the lock mounting plate 1 to loosen the fastener 4 which has been tightened in the assembling hole 12. Consequently, the attachment of the lock mounting plate 1 to the door plank may be loosened. Also, it may adversely affect assembling reliability and useful quality of the lock set and the lock mounting plate as explained above. Accordingly, there is a need for improving the lock mounting plate to modify the assembled reliability between the lock mounting plate and the fasteners.

The present invention intends to provide a lock mounting plate having an anti-loosening structure for connecting with a fixing member. The anti-loosening structure of the lock mounting plate consists of a fastener portion for connecting with a detent portion of the fixing member in such a way to mitigate and overcome the above problem. Accordingly, the fixing member permits the lock mounting plate to securely mount the lock set on the door plank such that the assembling quality of the lock mounting plate and the useful life of the lock set are increased.

### SUMMARY OF THE INVENTION

The primary objective of this invention is to provide a lock mounting plate having an anti-loosening structure for connecting with a fixing member, wherein the anti-loosening structure is provided on a periphery of an assembling hole to connect with the fixing member. Accordingly, the assembling quality of the lock mounting plate is increased.

The secondary objective of this invention is to provide the lock mounting plate having the anti-loosening structure for connecting with the fixing member, wherein the anti-loosening structure is provided on a periphery of an assembling hole and consists of a first inclined surface and a second inclined surface. An inclination of the first inclined surface is opposite to and greater than that of the second inclined surface.

The anti-loosening structure in accordance with the present invention is applied to a lock mounting plate and a fixing member. The lock mounting plate includes an axial hole and at least one assembling hole having a fastener portion on a periphery thereof. The fixing member includes a head portion, a shank portion and a detent portion formed on the head portion proximate to the shank portion. One side of the axial hole of the lock mounting plate is attached to a doorknob while the other side is attached to a returning spring. The fastener portion of the lock mounting plate is connected with the detent portion of the fixing member when the fixing member mounts the lock mounting plate to a door plank.

In a separate aspect of the present invention is that the fastener portion of the lock mounting plate consists of a first inclined surface and a second inclined surface opposite to the first inclined surface.

In a further separate aspect of the present invention is that the fastener portion of the lock mounting plate consists of a first inclined surface and a second inclined surface, wherein an inclination of the first inclined surface is opposite to and greater than that of the second inclined surface.

In a yet further separate aspect of the present invention is that the lock mounting plate includes a resilient lug on which to provide the assembling hole and the fastener portion.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exploded perspective view of a lock mounting plate and a fastener for a door lock mechanism in accordance with the prior art;

FIG. 2 is a perspective view of a pair of fixing members and a lock mounting plate having an anti-loosening structure in accordance with a first embodiment of the present invention for applying to the door lock mechanism;

FIG. 3 is an enlarged view of the anti-loosening structure of the lock mounting plate in accordance with the first embodiment of the present invention;

FIG. 4 is a cross-sectional view, taken along line 4-4 in FIG. 3, of the anti-loosening structure of the lock mounting plate engaged with the fixing member in tightening operation in accordance with the first embodiment of the present invention;

FIG. 5 is a cross-sectional view, similar to FIG. 4, of the anti-loosening structure of the lock mounting plate disengaged from the fixing member in loosening operation in accordance with the first embodiment of the present invention;

FIG. 6 is a perspective view of the fixing members and the lock mounting plate having the anti-loosening structure in accordance with a second embodiment of the present invention for apply to the door lock mechanism; and

FIG. 7 is an assembled cross-sectional view of the anti-loosening structure of the lock mounting plate engaged with the fixing member in accordance with the second embodiment of the present invention.

### DETAILED DESCRIPTION OF THE INVENTION

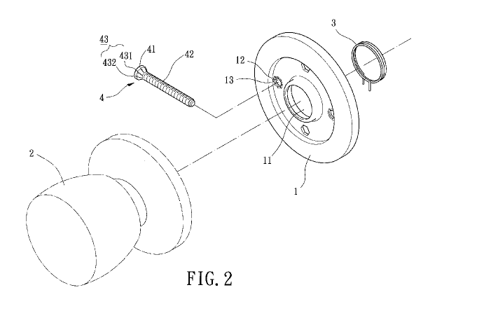

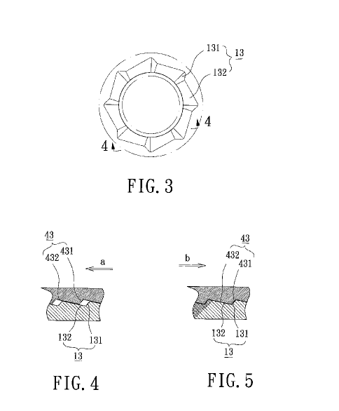

Referring initially to FIGS. 2 and 3, a fixing member applied to a lock mounting plate having an anti-loosening structure in accordance with a first embodiment of the present invention is disclosed and may be deployed on a door lock mechanism (not shown). In the illustrated embodiment, the door lock mechanism generally includes a lock mounting plate designated numeral 1, a doorknob designated numeral 2, a returning spring designated numeral 3 and a pair of fixing members designated numeral 4.

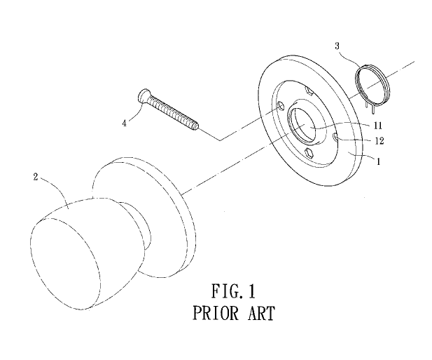

Still referring to FIG. 1, the construction of the lock mounting plate 1 in accordance with the present invention shall be described in detail. In the first embodiment, the lock mounting plate 1 is a one-piece member and circular in form with respect to a flat surface. The lock mounting plate 1 is constructed from a suitable material such as a metal material relatively rigid and strong to withstand normal usage of the door lock mechanism. Preferably, the lock mounting plate 1 has an upraised peripheral annular flange (not labeled) and an annular raised portion (not labeled) to intensify the entire structure, and thus uses the minimum of material in manufacture. The lock mounting plate 1 provides with an axial hole 11 in relation to a longitudinal line, and a plurality of assembling holes 12. There may be as many assembling holes 12 as desired, but in this instance a pair of the assembling holes is formed on the lock mounting plate 1. Formed on a periphery of the assembling hole 12 is a series of fastener portions 13. In the first embodiment, the fastener portion 13 consists of a first inclined surface 131 and a second inclined surface 132 opposite to the first inclined surface 131. An inclination of the first inclined surface 131 is opposite to and greater than that of the second inclined surface 132 so as to aid alignment with the fixing member 4. In installation, one side of the axial hole 11 of the lock mounting plate 1 is attached to the doorknob 2 while the other side is attached to the returning spring 3.

Still referring to FIG. 2, the constructions of the doorknob 2 and the returning spring 3 in accordance with the present invention shall be described in detail. The doorknob 2 has an ordinary or common form such as a circular form having an axial tube extended through the axial hole 11 of the lock mounting plate 1. In an alternative embodiment, the configuration of the doorknob 2 can be selected from a group consisting of a hemisphere, a spheroid and other suitable configuration. Preferably, the doorknob 2 may be combined with a rose escutcheon (not labeled). The returning spring 3 also has an ordinary or common form such as a circular form constructed from a common material. In the first embodiment, the returning spring 3 is constructed from a one-piece coil spring to provide a returning spring force which may exerts on the doorknob 2. Preferably, the returning spring 3 is designed for having a high degree of resilience. Consequently, the door lock mechanism (not shown) can limit rotation of the doorknob 2 about the axial hole 11 of the lock mounting plate 1 and then automatically return the doorknob 2 to an original angle position.

Still referring to FIG. 2, the construction of the fixing member 4 in accordance with the present invention shall be described in detail. The fixing member 4 includes a head portion 41, a shank portion 42 and a detent portion 43 formed on the head portion 41 proximate to the shank portion 42. It will be understood that the fixing member 4 can be selected from a screw member or other suitable fixing members. In the first embodiment, the detent portion 43 consists of a plurality of first inclined surface 431 and a plurality of second inclined surface 432 corresponding to the first inclined surface 131 and the second inclined surface 132 of the fastener portion 13 of the lock mounting plate 1. Correspondingly, an inclination of the first inclined surface 431 of the detent portion 43 of the fixing member 4 is opposite to and greater than that of the second inclined surface 432. The lock mounting plate 1 may be mounted to the door plank by securely fixing the fixing members 4 in screw holes (not shown).

Turning now to FIGS. 4 and 5, the anti-loosening operation of the detent portion 43 of the fixing member 4 with the fastener portion 13 of the door mounting plate 1. In tightening operation, the fixing member 4 is oriented and turned in the direction of the arrow identified as “a” in FIG. 4, i.e. in a right angle orientation relative to the fixing member 4. When this occurs, the second inclined surface 432 of the detent portion 43 of the fixing member 4 is engaged with the second inclined surface 132 of the fastener portion 13 of the door mounting plate 1. Due to the relatively smaller inclination of the second inclined surface 432 of the detent portion 43 of the fixing member 4, the second inclined surface 432 of the detent portion 43 of the fixing member 4 is capable of easily passing through the second inclined surface 132 of the fastener portion 13 of the door mounting plate 1. Accordingly, it may aid tightening operation of the fixing member 4 in the assembling hole 12 of the lock mounting plate 1. Conversely, in loosening operation, the fixing member 4 is oriented and turned in the direction of the arrow identified as “b” in FIG. 5, i.e. in a left angle orientation relative to the fixing member 4. When this occurs, the first inclined surface 431 of the detent portion 43 of the fixing member 4 is engaged with the first inclined surface 131 of the fastener portion 13 of the door mounting plate 1. Due to the relatively greater inclination of the first inclined surface 431 of the detent portion 43 of the fixing member 4, the first inclined surface 431 of the detent portion 43 of the fixing member 4 is incapable of easily passing through the first inclined surface 132 of the fastener portion 13 of the door mounting plate 1. In other words, unwanted loosening of the fixing member 4 from the assembling hole 12 can be avoided. Accordingly, it may aid anti-loosening the fixing member 4 from the assembling hole 12 of the lock mounting plate 1.

Particularly, when the doorknob 2 is turned and then released, the returning spring force of the returning spring 3 may automatically exert on both of the doorknob 2 and the lock mounting plate 1 of the door lock mechanism. Also, the returning spring force of the returning spring 3 may vibrate and affect the engagement of the fixing member 4 with the assembling hole 12 of the lock mounting plate 1. The disengagement of the fixing member 4 from the assembling hole 12 of the lock mounting plate can be avoided, if the engagement of the detent portion 43 of the fixing member 4 with the fastener portion 13 of the door mounting plate 1 in accordance with the present invention is used. The engagement of the fixing member 4 with the assembling hole 12 of the door mounting plate 1 may be affected by vibrations; even so, the connection of the detect portion 43 of the fixing member 4 with the fastener portion 13 of the door mounting plate 1 can still be insured and stabilized. In addition, the engagement of the first and second inclined surfaces 431, 432 of the detect portion 43 with the first and second inclined surfaces 131, 132 of the fastener portion 13 can further intensify a tightly assembled relationship between the fixing member 4 and the lock mounting plate 1, and prevent from creating noise in turning operation of the doorknob 2.

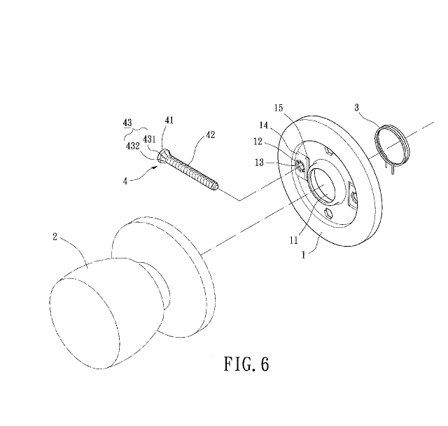

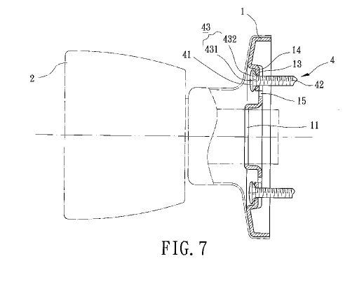

Turning now to FIGS. 6 and 7, reference numerals of the door lock mechanism such as the anti-loosening structure of the lock mounting plate 1 in accordance with the second embodiment of the present invention have applied the identical numerals of the first embodiment, as shown in FIG. 2. The construction of the door lock mechanism in accordance with the second embodiment of the present invention has similar configuration and same function as that of the first embodiment and detailed descriptions may be omitted.

Still referring to FIGS. 6 and 7, in comparison with the first embodiment, the lock mounting plate 1 in accordance with the second embodiment further includes a pair of resilient lugs 14 and a plurality of slots 15 thereof. Each of the resilient lugs 14 provides with at least one assembling hole 12 and at least one fastener portion 13 thereof. The resilient lug 14 is designed for having a high degree of resilience and flexibility to withstand normal tightening operation. The slot 15 permits resiliently deforming the corresponding resilient lug 14 to aid the tightening operation by receiving the resilient lug 14. In the second embodiment, the slot 15 is preferably located between the resilient lug 14 and the axial hole 11 so that the slot 15 separates the resilient lugs 14 from the axial hole 11 so as to avoid affecting the axial hole 11. In an alternative embodiment, the resilient lugs 14 may be upraised from the flat surface of the lock mounting plate 1 in a punching process. In tightening operation, a longitudinally pressing force from the fixing member 4 exerts on the resilient lug 14 which may be deformed such that the engagement of the detent portion 43 of the fixing member 4 with the fastener portion 13 of the door mounting plate 1 is further insured. Meanwhile, the slot 15 provides with a space for permitting deformation of the resilient lug 14 therein.

It will be apparent from the aforementioned discussions that the conventional lock mounting plate 1 has no skidproof structure for connecting the fixing member 4. However, the fixing member 4 may be fallen off from the assembling hole 12 of the lock mounting plate 1 after long-term use. As best shown in FIGS. 2 and 6, the engagement of the detent portion 43 of the fixing member 4 with the fastener portion 13 of the door mounting plate 1 in accordance with the present invention is deployed such that the lock mounting plate 1 can be securely mounted on the door plank (not shown).

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. An anti-loosening structure for a door lock mechanism comprising:
a lock mounting plate including an axial hole, at least one assembling hole and at least one fastener portion, the axial hole being adapted to combined with a doorknob and said fastener portion being provided on a periphery of the assembling hole; and
at least one fixing member having a head portion, a shank portion and a detent portion, said detent portion formed on the head portion corresponding to said fastener portion of the assembling hole of the lock mounting plate;
wherein when the fixing member being received in the assembling hole of the lock mounting plate, said detent portion of the fixing member being engaged with said fastener portion of the assembling hole of the lock mounting plate such that the engagement of the fixing member with the lock mounting plate being insured.

2. The anti-loosening structure for the door lock mechanism as defined in claim 1, wherein said fastener portion consisting of a first inclined surface and a second inclined surface.

3. The anti-loosening structure for the door lock mechanism as defined in claim 2, wherein an inclination of the first inclined surface of the fastener portion of the lock mounting plate being opposite to and greater than that of the second inclined surface.

4. The anti-loosening structure for the door lock mechanism as defined in claim 1, wherein said detent portion of the fixing member consisting of a first inclined surface and a second inclined surface.

5. The anti-loosening structure for the door lock mechanism as defined in claim 4, wherein an inclination of the first inclined surface of the detent portion of the fixing member being opposite to and greater than that of the second inclined surface.

6. The anti-loosening structure for the door lock mechanism as defined in claim 1, wherein the lock mounting plate further including at least one resilient lug on which to provide said assembling hole and fastener portion thereof.

7. The anti-loosening structure for the door lock mechanism as defined in claim 6, wherein the lock mounting plate further including at least one slot adjacent to the resilient lug so as to permit deformation of the resilient lug.

8. The anti-loosening structure for the door lock mechanism as defined in claim 7, wherein the slot of the lock mounting plate being located between the axial hole and the resilient lug such that the slot separates the resilient lug from the axial hole.

9. The anti-loosening structure for the door lock mechanism as defined in claim 6, wherein the resilient lug being upraised from a flat surface of the lock mounting plate in a punching process.

10. The anti-loosening structure for the door lock mechanism as defined in claim 1, wherein said detent portion formed on the head portion of the fixing member being proximate to the shank portion.

11. The anti-loosening structure for the door lock mechanism as defined in claim 1, wherein the fixing member being selected from a screw member.
